(19) United States
(12) Patent Application Publication
(10) Pub. No.: US 2017/0050880 A1
(43) Pub. Date: Feb. 23, 2017

(54) PARTIALLY CRYSTALLISED GLASS PLATE

(71) Applicant: EUROKERA S.N.C., Chateau Thierry (FR)

(72) Inventors: Kamila PLEVACOVA, Paris (FR); Emmanuel LECOMTE, Nesles La Montagne (FR)

(73) Assignee: EUROKERA S.N.C., Chateau Thierry (FR)

(21) Appl. No.: 15/307,268

(22) PCT Filed: Apr. 28, 2015
(86) PCT No.: PCT/FR2015/051148

§ 371 Date: Oct. 27, 2016

(30) Foreign Application Priority Data
Apr. 29, 2014 (FR) 1453866

(51) Int. Cl. C03C 10/00; F24B 1/191; H05B 6/12; F24C 15/04; C03C 4/20; C03B 32/02

(52) U.S. Cl. CPC C03C 10/0009; C03C 4/20; C03B 32/02; H05B 6/1209; F24C 15/04; F24B 1/191; C03C 2204/04

(57) ABSTRACT

A subject matter of the invention is a partially crystalline glass plate, the linear thermal expansion coefficient of which is within a range extending from 20 to 40×10⁻⁷/K and the chemical composition of which comprises the following constituents, varying within the limits by weight defined below:

| | |
|---|---|
| SiO₂ | 55-70% |
| Al₂O₃ | 12-25% |
| Li₂O | 1-2% |
| K₂O | 0-<3% |
| Na₂O | 0-<3% |
| Li₂O + Na₂O + K₂O | 1-<7% |
| RO | 2-10% |
| (WHERE RO = MgO + CaO + SrO + BaO + ZnO) | |
| TiO₂ | 0-5% |
| ZrO₂ | 0.1-3%. |

The invention relates to the field of glass plates, in particular used in induction cooking devices, as panels for oven doors or windows, or also as fireplace inserts.

The abovementioned applications require plates exhibiting a high thermomechanical strength, in particular an excellent resistance to thermal shock, and also resistance to corrosive atmospheres at high temperature.

It is an aim of the invention to provide glass plates which are particularly well suited to these applications.

To this end, a subject matter of the invention is a partially crystalline glass plate, the linear thermal expansion coefficient of which is within a range extending from 20 to 40×10⁻⁷/K and the chemical composition of which comprises the following constituents, varying within the limits by weight defined below:

| | |
|---|---|
| SiO₂ | 55-70% |
| Al₂O₃ | 12-25% |
| Li₂O | 1-2% |
| K₂O | 0-<3% |
| Na₂O | 0-<3% |
| Li₂O + Na₂O + K₂O | 1-<7% |
| RO | 2-10% |
| (WHERE RO = MgO + CaO + SrO + BaO + ZnO) | |
| TiO₂ | 0-5% |
| ZrO₂ | 0.1-3%. |

The inventors have been able to demonstrate that the partial crystallization of a glass exhibiting such a composition makes it possible to obtain a material having a high thermomechanical strength and chemical resistance. The material is provided in the form of a glass comprising, within it, a certain proportion of crystals. The crystals advantageously exhibit a mean size of at most 1 μm, in particular 500 nm and even 100 nm, so that the plate is sufficiently transparent.

Preferably, the plate comprises, within the glass, crystals of β-quartz structure, in order to adjust the linear thermal expansion coefficient in the desired range. The linear thermal expansion coefficient of the plate is preferably within a range extending from 25 to 38×10⁻⁷/K, in particular from 30 to 35×10⁻⁷/K. The linear thermal expansion coefficient is measured according to the standard ISO 7991:1987 between 20 and 300° C.

The chemical composition of the plate according to the invention preferably comprises (or is essentially composed of) the following constituents, varying within the limits by weight defined below:

| SiO₂ | 55-70%, in particular 65-70% |
|---|---|
| Al₂O₃ | 12-25%, in particular 18-21% |
| B₂O₃ | 0-0.5%, in particular 0 |
| Li₂O | 1-2%, in particular 1.2-1.8% |
| K₂O | 0-<3%, in particular 0-2% |
| Na₂O | 0-<3%, in particular 0-2% |
| Li₂O + Na₂O + K₂O | 1-<5% |
| CaO | 0-10%, in particular 0-5% |
| MgO | 0-5%, in particular 1-4% |
| SrO | 0-5%, in particular 0-3% |
| BaO | 0-5%, in particular 0-2% |
| ZnO | 0-5%, in particular 1-3% |
| RO | 2-10% |
| (WHERE RO = MgO + | |
| CaO + SrO + BaO + ZnO) | |
| TiO₂ | 0-3%, in particular 0.5-3% |
| ZrO₂ | 0.1-3%, in particular 0.3-2% |
| SnO₂ | 0-1%, in particular 0.2-1% |
| As₂O₃ + Sb₂O₃ | <0.1%. |

The expression “is essentially composed of” should be understood in the sense that the abovementioned oxides constitute at least 96%, indeed even 98%, of the weight of the glass.

The silica (SiO₂) is the main network-forming oxide of the glass. High contents will contribute to increasing the viscosity of the glass beyond what is acceptable, whereas excessively low contents will increase the thermal expansion coefficient. The alumina (Al₂O₃) also contributes to increasing the viscosity of the glass and to reducing its expansion coefficient. It has a beneficial effect on the Young's modulus.

The alkaline earth metal oxides, in particular lime (CaO) and also barium oxide (BaO), are of use in facilitating the melting of the glass and the refining thereof, due to their effect in reducing the viscosity at high temperatures.

The alkali metal oxides and more particularly sodium oxide Na₂O and potassium oxide K₂O exhibit the disadvantage of increasing the thermal expansion coefficient, with the result that their content is limited. The content of Li₂O is advantageously between 1.2 and 1.8% and preferably at most 1.5%. Low contents of lithium oxide in addition allow the use of economical lithium carriers comprising coloring impurities, for example iron oxide, such as spodumene, lithium feldspars, petalite, or also glass or glass-ceramic cullet with a composition suitable for the preparation of cooking surfaces. The latter point is particularly advantageous in the case of plates exhibiting a high light transmission and which are colorless (clear plates).

The titanium oxide (TiO₂) and zirconium oxide (ZrO₂) are nucleating agents which make possible in particular the formation of crystals of β-quartz structure. The content of TiO₂ is advantageously between 0.5 and 3%. The content of ZrO₂ is advantageously between 0.3 and 2%. The TiO₂:ZrO₂ molar ratio is between 3:1 and 6:1, preferably between 4:1 and 6.1. Thus, it is possible to obtain a partially crystalline glass exhibiting a linear expansion coefficient of between 20 and 40×10⁻⁷/K. Furthermore, a limited ZrO₂ content makes it possible to reduce the liquidus temperature and the energy necessary for the manufacture of the glass.

The composition of the glass can comprise other constituents.

They can be refining agents, in a content generally of at most 1% or 2%, in particular chosen from sulfates, halogens (in particular chlorine), sulfides (in particular zinc sulfide), oxides of arsenic, antimony, iron, tin, cerium or vanadium, or any one of their mixtures. The refining agents serve to free the molten glass from any gas pockets. Among these agents, tin oxide is particularly preferred and its content by weight is advantageously within a range extending from 0.1%, in particular 0.2%, to 0.6%, in particular 0.5%. The chemical composition of the plate according to the invention is preferably such that the sum of the contents by weight of arsenic oxide and antimony oxide is at most 0.1%, in particular is zero. The chemical composition of the plate according to the invention preferably comprises tin oxide SnO₂ in a content by weight of at most 1%.

They can also be coloring agents, such as iron, cobalt, vanadium, cooper, chromium or nickel oxides, selenium or sulfides. In the majority of the applications, in particular for the plates used as panels for oven doors or windows or as fireplace inserts or as fire-resistant glazings, the content of coloring agents will be as low as possible in order for the plate to indeed be colorless and to exhibit a light transmission which is as high as possible. The coloring agents will then be, if appropriate, present only as impurities, in the form of traces. The content of iron oxide, present as impurity in the majority of the starting materials, is preferably at most 400 ppm (1 ppm=0.0001%), in particular 200 ppm and even 100 ppm.

The partially crystalline glass plate preferably has a thickness within a range extending from 1 to 8 mm, in particular from 2 to 6 mm, indeed even from 2 to 4 mm. Its lateral dimensions typically range from 30 cm to 200 cm, in particular from 50 cm to 150 cm.

The plate according to the invention preferably has a light transmission factor (according to the standard EN 410) of at least 50%, in particular 60% and even 70% or 80%, indeed even 85% or 90%. Such values are particularly appreciable in the case of plates used as oven doors, fireplace inserts or fire-resistant glazings, in order to provide the users with the best possible visibility.

Another subject matter of the invention is a process for obtaining a plate according to the invention, comprising a step melting the glass, a step of shaping said glass in the form of a plate and then a step of crystallization.

The melting is typically carried out in refractory furnaces with the help of burners using air or better still oxygen as oxidant and natural gas or fuel oil as fuel. Resistors made of molybdenum or platinum immersed in the molten glass can also provide all or part of the energy used to obtain a molten glass. Starting materials (silica, spodumene, petalite, etc.) are introduced into the furnace and undergo various chemical reactions under the effect of the high temperatures, such as decarbonation reactions, melting reactions proper, or the like. As indicated above, the composition according to the invention makes it possible to obtain clear plates using economical lithium carriers comprising coloring impurities. The mixture of starting materials thus preferably comprises at least one material chosen from spodumene, petalite, a lithium feldspar or cullet of glass-ceramic used as cook top, or also mother glass cullet of such a glass-ceramic. The maximum temperature reached by the glass is typically at least 1500° C., in particular between 1600 and 1700° C. The glass can be shaped into plates in a known way by rolling the glass between metal or ceramic rollers, by drawing (upwards or downwards) or also by the float glass method, a technique consisting in pouring the molten glass onto a bath of molten tin.

The crystallization step preferably involves a thermal cycle employing a rise in temperature to a crystallization temperature preferably within a range extending from 850 to 1000° C., in particular from 900 to 960° C. The choice of the crystallization temperatures and/or times, to be adjusted to each composition, makes it possible to alter the thermal expansion coefficient of the material obtained by varying the nature and the amount of crystals. Preferably, the thermal cycle comprises a rise to a temperature of between 650° C. and 850° C. over a period of time of 5 to 60 minutes and then a rise to a temperature of between 850 and 1000° C. over a period of time of 5 to 60 minutes.

Another subject matter of the invention is an induction cooking device comprising at least one plate according to the invention and at least one inductor.

It is preferable for the glass plate to be capable of concealing the inductors, the electrical wiring and also the control and monitoring circuits of the cooking device. To this end, it is possible to provide a portion of the surface of the plate (that which, in the cooking device, is located facing the components to be concealed) with a coating deposited on and/or under the plate, said coating having the ability to absorb and/or reflect and/or scatter light radiation. The coating can be deposited under the plate, that is to say on the surface facing the internal components of the device, also known as “lower face”, and/or on the plate, that is to say as upper face. The coating can be a layer having an organic base, such as a layer of paint, resin or lacquer, or a layer having an inorganic base, such as an enamel or a metal layer or a layer of an oxide, nitride, oxynitride or oxycarbide of a metal. Preferably, the organic layers will be deposited as lower face, while the inorganic layers, in particular the enamels, will be deposited as upper face. The various internal components of the cooking device can also be concealed by an opaque sheet arranged between these components and the plate, for example a sheet of mica. Alternatively or simultaneously, the composition of the glass can comprise coloring agents, such as iron oxide, present as an impurity in the majority of the starting materials, cobalt oxide, chromium oxide, copper oxide, vanadium oxide, nickel oxide or also selenium. The total content by weight of coloring agents is normally at most 2%, indeed even 1%. The introduction of one or more of these agents can result in a dark glass plate, with a very low light transmission (typically of at most 3%, in particular 2% and even 1%), being obtained, which plate will exhibit the advantage of concealing the inductors, the electrical wiring and also the control and monitoring circuits of the cooking device.

In addition to the glass plate and at least one inductor (preferably three or four and even five), the cooking device can comprise at least one light-emitting device, at least one control and monitoring device, the assembly being included in a housing.

A, the or each light-emitting device is advantageously chosen from light-emitting diodes (for example included in 7-segment displays), liquid crystal displays (LCDs), light-emitting diode displays which are optionally organic (OLEDs), and fluorescent displays (VDs). The colors seen through the plate are diverse: red, green, blue and all the possible combinations, including yellow, purple, white, and the like. These light-emitting device can be purely decorative, for example can visually separate different regions of the plate. Generally, however, they will have a functional role by displaying various items of information of use to the user, in particular indication of the heating power, of the temperature, of cooking programs, of cooking time or of regions of the plate exceeding predetermined temperature. The control and monitoring devices generally comprise touch-sensitive controls, for example of the capacitive infrared type. All of the internal components are generally attached to a housing, often a metal housing, which thus constitutes the lower part of the cooking device, normally concealed in the worktop or in the body of the cooker.

Another subject matter of the invention is a domestic oven door comprising at least one plate according to the invention, in particular as glass plate intended to be the closest to the chamber of said oven.

The oven door according to the invention preferably comprises an internal glass plate and an external glass plate, these two plates forming the two main external flat faces of the door, so that, once the door is fitted to the oven, the internal glass plate is the closest to the chamber of the oven and the external plate is the closest to the user. The oven door according to the invention preferably comprises at least one intermediate glass plate located between the internal glass plate and the external glass plate and separated from each of the latter by at least one band of air. A preferred door comprises three or four plates and thus one or two intermediate glass plate(s).

At least one glass plate, in particular one intermediate glass plate, is advantageously coated with a low emissivity layer, in particular with a layer of a transparent conductive oxide (TCO), such as, for example, doped tin oxide, in particular doped with fluorine or with antimony. The presence of such layers makes it possible to reduce the heat exchanges between the glass plates, thus contributing to improving the thermal insulation of the door.

Another subject matter of the invention is a fireplace insert comprising at least one glass plate according to the invention.

Finally, a subject matter of the invention is a fire-resistant glazing comprising at least one glass plate according to the invention.

The implementational examples which follow illustrate the invention without limiting it.

Glasses having the chemical compositions presented in table 1 were melted and put into plate form.

The plates obtained were subsequently partially crystallized by subjecting them to a thermal cycle characterized by rapid heating up to 590° C., then a rise up to 820° C. at a rate of 10° C./min and, finally, a rise up to 930° C. at a rate of 20° C./min, followed by maintenance at this temperature for 6 minutes.

Table 1 below indicates, for each example, in addition to the chemical composition expressed as percentages by weight, the liquidus temperature, the temperatures corresponding to a viscosity of 10⁴ and 10¹³ poises (1 poise=0.1 Pa.s), respectively denoted T4 and T13, and also the linear thermal expansion coefficient (denoted TEC) for the glass and for the partially crystalline glass. The linear thermal expansion coefficients are measured according to the standard ISO 7991:1987 between 20 and 300° C.

TABLE 1

| | 1 | 2 |
|---|---|---|
| SiO₂ | 67.0 | 66.9 |
| Al₂O₃ | 19.6 | 19.6 |
| Na₂O | 0.2 | 1.3 |
| K₂O | 0.2 | 1.6 |
| Li₂O | 1.5 | 1.5 |
| MgO | 1.2 | 3.0 |
| BaO | 0.8 | 0.8 |
| CaO | 4.2 | 0 |
| TiO₂ | 2.6 | 2.6 |
| ZrO₂ | 0.8 | 0.8 |
| ZnO | 1.6 | 1.6 |
| SnO₂ | 0.3 | 0.3 |
| Liquidus (° C.) | <1350 | 1310 |
| T4 (° C.) | 1344 | 1351 |
| T13 (° C.) | 724 | 700 |
| TEC (10⁻⁷/° C.) | 43 | 44 |
| Crystalline glass | | |
| TEC (10⁻⁷/° C.) | 34 | 37 |
| Light transmission (%) | 89 | 82 |

1. A partially crystalline glass plate comprising SiO₂, Al₂O₃, Li₂O, and ZrO₂,
wherein a linear thermal expansion coefficient of the plate is from 20 to 40+10⁻⁷/K and
a chemical composition of the plate comprises, by weight:

| | |
|---|---|
| SiO₂ | 55-70% |
| Al₂O₃ | 12-25% |
| Li₂O | 1-2% |
| K₂O | 0-<3% |
| Na₂O | 0-<3% |
| Li₂O + Na₂O + K₂O | 1-<7% |
| MgO + CaO + SrO + BaO + ZnO | 2-10% |
| TiO₂ | 0-5% |
| ZrO₂ | 0.1-3% |

2. The plate of claim 1, wherein the content by weight of Li₂O is between 1.2 and 1.8%.

3. The plate of claim 1, wherein the content by weight of TiO₂ is between 0.5 and 3%.

4. The plate of claim 1, wherein the content by weight of ZrO₂ is between 0.3 and 2%.

5. The plate of claim 1, comprising a nonzero amount of TiO₂ of at most 5 wt %, wherein a TiO₂:ZrO₂ molar ratio is between 3:1 and 6:1.

6. The plate of claim 1, wherein a sum of contents by weight of arsenic oxide and antimony oxide, if present, is at most 0.1%.

7. The plate of claim 1, wherein a content of tin oxide SnO₂, if present, at most 1%.

8. The plate of claim 1, comprising, within the glass, crystals of β-quartz structure.

9. The plate of claim 1, which has a light transmission factor of at least 50%.

10. A process for obtaining the plate of claim 1, the process comprising melting a glass, shaping said glass in the form of a plate, and then crystallizing the glass.

11. An induction cooking device comprising at least one plate of claim 1 and at least one inductor.

12. A domestic oven door comprising at least one plate of claim 1.

13. A fireplace insert comprising at least one glass plate of claim 1.

14. A fire-resistant glaring comprising at least one glass plate of claim 1.

15. The plate of claim 1, wherein a content of iron oxide is at most 400 ppm.

16. The plate of claim 1., which has a light transmission factor of at least 80%.
